(19) United States
(12) Patent Application Publication
(10) Pub. No.: US 2005/0159888 A1
(43) Pub. Date: Jul. 21, 2005

(54) Vehicle mounted information guidance device

(75) Inventor: Kazuo Miyata, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/026,018

(22) Filed: Jan. 3, 2005

(30) Foreign Application Priority Data
Jan. 16, 2004 (JP) 2004-9457

(51) Int. Cl. G01C 21/30

(52) U.S. Cl. 701/209; 701/211; 340/995.1

(57) ABSTRACT

In a vehicle mounted information guidance device which guides a vehicle along a route on a map displayed on a screen on the basis of the present position of the vehicle and a destination, when a user sets his desired retrieving location at a preparatory stage for setting the destination, the device changes a screen into a state of display where the present position of the vehicle and the retrieving location are displayed at the same time on the map displayed on the screen and enables the user to grasp the relationship between the present position of the vehicle and the retrieving location in this state of display and to set whether or not the user intends to make the retrieving location the destination.

### BACKGROUND OF THE INVENTION

1. Field of the Invention

The present invention relates to a vehicle mounted information guidance device, more particularly, relates to a vehicle mounted information guidance device that displays the relationship between the present position of a vehicle and a retrieving location desired by a user when the user sets the retrieving location at a preparatory stage in which the user sets a destination to have the vehicle guided to the destination.

2. Description of the Related Art

Vehicle mounted information devices have been conventionally used that detect the present position of a vehicle by a navigation system using a GPS (Global Positioning System) or the like and display the present position of a vehicle as a present vehicle position along with a road map on a display device. The vehicle mounted information guidance devices not only display the present vehicle position on the road map but also display various kinds of facilities (for example, gas station, restaurant, amusement park and soon) as facility marks on the road map.

Some of the conventional vehicle mounted information guidance devices display a route from the present vehicle position to a destination when a user inputs the destination to an input device and retrieves the destination. For example, the user sets the present vehicle position (for example, name (of location) and a destination (for example, name of location) and makes the vehicle mounted information guidance device to display a map of selected map section on a display device. At this point, when the present vehicle position comes nearer to the destination as the vehicle moves nearer to the destination, the vehicle mounted information guidance device changes the map section in sequence.

For example, first, the vehicle mounted information guidance device selects a large map section to display the large map section including cities, towns, and villages on the display device in which the destination is blinked. Then, when the vehicle comes near to the destination, the vehicle mounted information guidance device selects a middle map section to display the middle map section in which the destination is blinked in the similar way. Then, when the vehicle arrives in a vicinity of the block of the destination and the vehicle mounted information guidance device selects a small map section, and the user can recognize an entry to the destination (see patent document 1).

In this manner, in the conventional vehicle mounted information guidance device, a CPU (Central Processing Unit) retrieves an electronic map concerned from a plurality of electronic maps stored in an external storage device on the basis of retrieval information related to the present position or the destination input by the input device and displays the retrieved electronic map on the display device to point out the present position or the destination clearly on the electronic map. Here, on the basis of retrieval information related to both the input present position and the input destination, the electronic map including the present position and the destination is retrieved from the plurality of stored electronic maps and is displayed and predetermined marks are also displayed at positions corresponding to the present position and the destination on the electronic map.

[Patent document] Japanese Unexamined Patent Publication No. 6-60298 (paragraph [0011] to paragraph [0042], FIG. 1 to FIG. 7).

Since the conventional vehicle mounted information guidance device is constructed in the manner described above, the present position and the destination can be displayed on the screen of the display device. However, when a user sets a destination and retrieves a route to the destination, the user needs to set the destination once and then to retrieve the route to the destination. At this point, there are many cases where when the user sets the destination, the user wavers in judgment for grasping the destination whether the destination is appropriate for his desired intension or not.

Hence, in the conventional vehicle mounted information guidance device, after a user set a destination and retrieved a route to the destination to acquire information related to the destination, the user needs to judge whether the destination is appropriate or not. Then, when the destination is not appropriate, the user needs to set another destination and to retrieve a route to the destination again.

In this manner, in the conventional vehicle mounted information guidance device, when a user sets a destination and retrieves a route to the destination to acquire information related to the destination, the user needs to judge whether the destination is appropriate or not. Then, when the destination is not appropriate, the user needs to set another destination. This presents a problem that it is extremely burdensome for the user to set a desired destination and to retrieve a route to the destination and that an operation of setting a destination is troublesome for the user.

### SUMAMRY OF THE INVENTION

The present invention has been made to solve the above described problem and an object of the present invention is to provide a vehicle mounted information guidance device that ensures extreme ease in the setting of a destination and in the retrieving a route to the destination.

A vehicle mounted information guidance device in accordance with the present invention that guides a vehicle along a route on a map displayed on a screen on the basis of a present position of the vehicle and a destination, the device is characterized by including: a display control unit that brings the screen into a state of display where the present position and a retrieving location desired by a user are displayed at the same time on the map displayed on the screen when a user sets the retrieving location at a preparatory stage for setting the destination; and setting unit through which the user sets whether or not the user intends to make the retrieving location the destination according to a result of grasping a relationship between the present position and the retrieving location in the state of display. According to the present invention, the vehicle mounted information guidance device is constructed in such a way that when a user sets a desired retrieving location at a preparatory stage for setting a destination, the device brings a screen into a state of display where the present position and the retrieving location are displayed at the same time on the map displayed on the screen and that the user grasps the relationship between the present position and the retrieving location in the state of display and sets whether or not the user intends to make the retrieving location for the destination. Hence, the user can grasps the relationship between the present position and the retrieving location at the preparatory stage for setting the destination and then can set the destination. As a result, the device produces an effect that the user can set the destination and retrieve a route with extreme ease.

### BRIEF DESCRIPTION OF THE DRAWINGS

FIG. 1 is a block diagram to show a vehicle mounted information guidance device in accordance with embodiment 1 of the present invention.

FIG. 2 is a flow chart to describe one example of operations of the vehicle mounted information guidance device shown in FIG. 1.

FIG. 3 is an illustration to show one example of a present vehicle position mark and a retrieving location mark displayed on the vehicle mounted information guidance device shown in FIG. 1.

FIG. 4 is an illustration to show a direction in which the retrieving location mark shown in FIG. 3 is moved.

FIG. 5 is an illustration to show one example of a recommended guiding route from the present vehicle position mark to the retrieving location mark along with a running distance which are displayed on the vehicle mounted information guidance device shown in FIG. 1.

FIG. 6 is an illustration to show one example of a screen that displays the present vehicle position mark, the retrieving location mark, and a time required.

FIG. 7 is an illustration to show one example of a screen that displays the present vehicle position mark, the retrieving location mark, and an expected arrival time.

FIG. 8 is an illustration to show one example of a screen that displays the present vehicle position mark, the retrieving location mark, a difference in elevation above the sea level, and a height above the sea level.

FIG. 9 is an illustration to show one example of a screen that displays the present vehicle position mark, the retrieving location mark, a running time, a time required, and a difference in elevation above the sea level.

FIG. 10 is an illustration to show one example of a screen display when the retrieving location mark starts to move downward on the screen.

FIG. 11 is an illustration to show one example of a screen display when the retrieving location mark is moving downward on the screen.

FIG. 12 is an illustration to show one example of a screen display when the retrieving location mark moves downward on the screen and reaches near the lower end side of the screen.

FIG. 13 is an illustration to show the state of screen display when the retrieving location mark moves further downward from a state shown in FIG. 12.

FIG. 14 is an illustration to show one example of a screen display when the present vehicle position mark moves downward and reaches near the upper end side of the screen.

FIG. 15 is an illustration to show the state of screen display when the retrieving location mark moves further downward from a state shown in FIG. 14.

FIG. 16 is an illustration to show the state of screen display when the retrieving location mark moves still further downward from a state shown in FIG. 15.

### DETAILED DESCRIPTION OF THE PREFERRED EMBODIMENT

### Embodiment 1

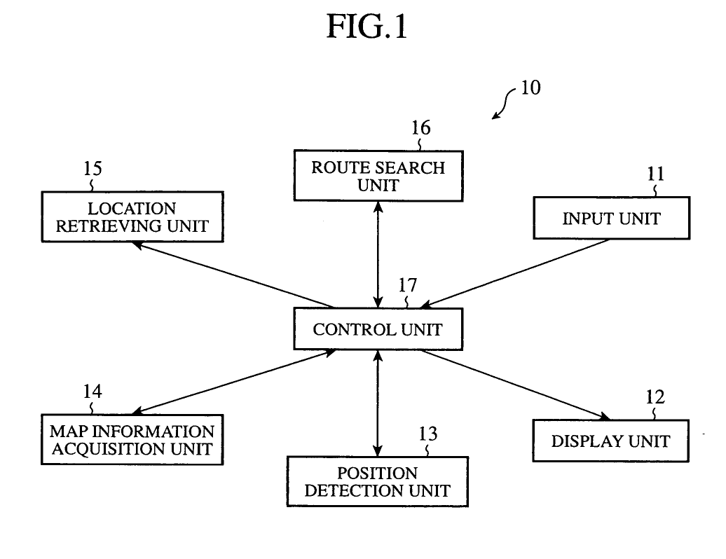

FIG. 1 shows a vehicle mounted information guidance device in accordance with embodiment 1 to put the present invention into practice. In FIG. 1, a vehicle mounted information guidance device (hereinafter referred to as “navigation device) 10 shown in the drawing includes input unit (for example, remote controller and key operating board, “setting unit”) 11, display unit (monitor) 12, position detection unit 13, map information acquisition unit 14, location retrieving unit 15, route search unit 16, and control unit (“display control unit”) 17, and the control unit 17 exercises control over the input unit 11, the display unit 12, the position detection unit 13, the map information acquisition unit 14, the location retrieving unit 15, and the route search unit 16.

A user can set a retrieving location which is a candidate site as a destination to set, through the input unit 11 at a preparatory stage of setting a destination in the navigation device 10. For example, when a location retrieval command for retrieving a location desired by the user is input, the location retrieving unit 15 performs a facility retrieval and a map retrieval under control of the control unit 17 to acquire map information including a retrieving location designated by the location retrieval command as location map information from map information stored in, for example, CD-ROM, DVD-ROM, or HDD (hereinafter referred to as “map information storage part”, though which is not shown).

Then, the control unit 17 displays this location map information as a location map on the display unit 12. The user inputs his desired retrieving location on the location map through the input unit 11. Then, when the retrieving location is input, a route between a present vehicle position and the retrieving location is retrieved in the manner to be described later.

On the other hand, the position detection unit 13 detects the present position of a vehicle on the basis of GPS data received from a GPS satellite and/or gyrocompass data acquired from a gyrocompass sensor and outputs the present position of a vehicle as a present vehicle position to the control unit 17. The control unit 17 controls the map information acquisition unit 14 on the basis of the present vehicle position to acquire map information which includes the vehicle present position from the map information storage part through the map information acquisition unit 14. Then, the control unit 17 displays a map corresponding to the map information on the screen of the display unit 12 and displays the present vehicle position on the map. At this time, as will be described later, the present vehicle position and the retrieving location are displayed at the same time on the screen of the display unit 12.

When the present vehicle position and the retrieving location are displayed as described above and then a cursor key provided in the input unit 11 is operated, a retrieving location mark is moved on the screen as will be described later, whereby the retrieving location can be changed in position. Then, when the retrieving location mark is stopped, the control unit 17 controls the route search unit 16 to search the map information stored in the map information storage part for a route from the present vehicle position to the retrieving location and selects one which is most appropriate utilizing conventional technology to display a searched route as a recommended route on the map displayed on the display device 12.

Further, when the retrieving location is set as a destination in the manner to be described later, the route search unit 16 searches the map information stored in the map information storage part for all detailed routes from the present vehicle position to the destination, and the control unit 17 displays the present vehicle position on the map displayed on the display device 12 according to these all routes and gives the user a route guidance.

Next, operation will be described.

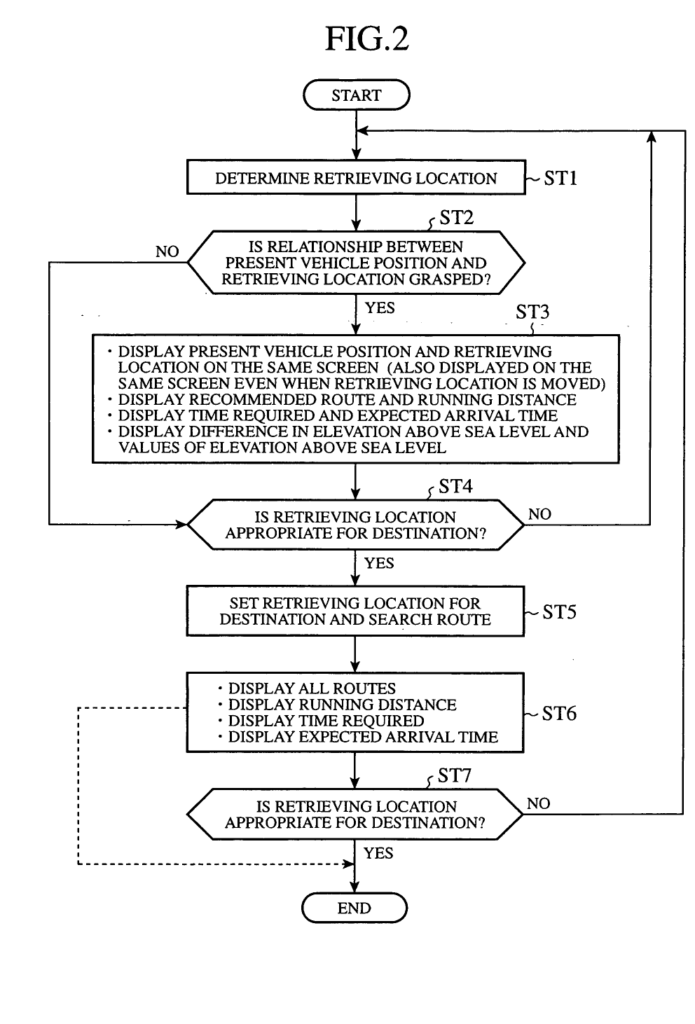

Referring to FIG. 1 and FIG. 2, when the user intends to perform a location retrieval, as described above, allocation retrieval command is input and location map information is displayed as a location map on the display unit 12. Then, when the user inputs his desired retrieving location on the location map through the input unit 11, the control unit 17 recognizes the determination of a retrieving location (step ST1) and displays on the display unit 12 a message to the effect whether a relationship between the present vehicle position and the retrieving location (hereinafter referred to simply as “location relationship”) needs to be grasped or not (step ST2).

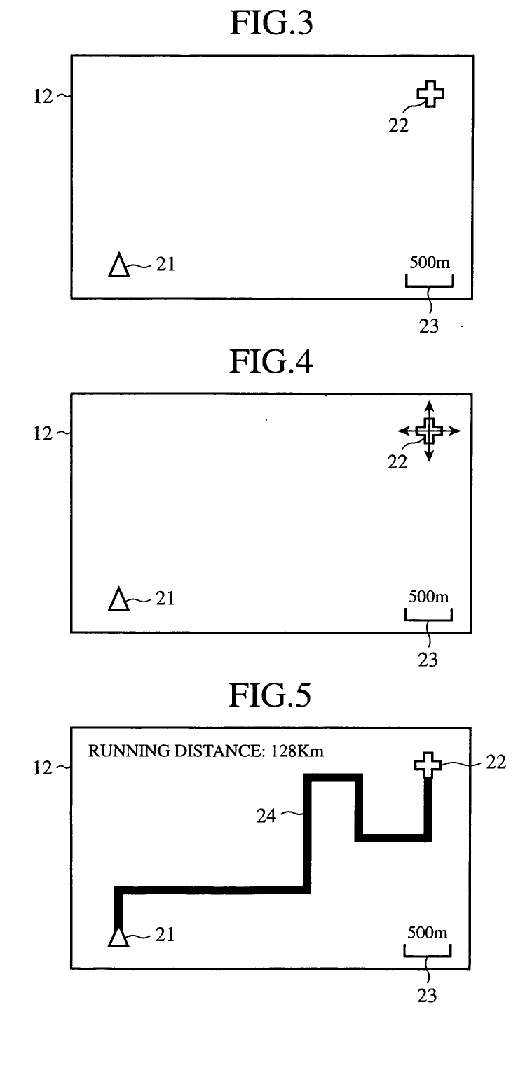

When the user inputs through the input unit 11 a command of showing that the user desires to grasp the location relationship, the control unit 17 performs an operation of displaying the location relationship in the following manner (step ST3). At step ST3, the control unit 17, as shown in FIG. 3, displays a present vehicle position mark 21 and a retrieving location mark 22 on the map displayed on the display unit 12. At this time, a scale 23 is displayed in the right lower corner of the screen.

In this regard, the control unit 17 adjusts the scale of map displayed on the display unit 12 in such a way that the present vehicle position mark 21 and the retrieving location mark 22 are displayed on the same screen. In the example shown in FIG. 3, the map is displayed on such an adjusted scale that displays the present vehicle position mark 21 and the retrieving location mark 22 at diagonal positions in the screen in such a way as to make the best possible use of the screen.

When the present vehicle position mark 21 and the retrieving location mark 22 are displayed on the same screen as described above, the control unit 17 enables the retrieving location mark 22 to move on the screen. When the user operates a cursor key provided in the input device 11, the retrieving location mark 22 moves in the longitudinal and lateral directions, as shown by solid arrows in FIG. 4, according to the operation of cursor key. In this manner, when the retrieving location mark 22 moves on the screen, the control unit 17 changes the scale of map in such a way that the present vehicle position mark 21 and the retrieving location mark 22 are displayed on the same screen (this point will be described later).

Then, when the retrieving location mark 22 does not move for a predetermined time, the control unit 17 controls the route search unit 16 to search the map information stored in the map information storage part for a route connecting the present vehicle position and the retrieving location concerned and displays a recommended route 24 on the screen, as shown in FIG. 5. At this time, the distance between the present vehicle position and the retrieving location concerned, that is, the running distance of recommended route 24 is displayed in the left upper corner of the screen (in the example shown in FIG. 5, it is displayed that running distance is 128 km).

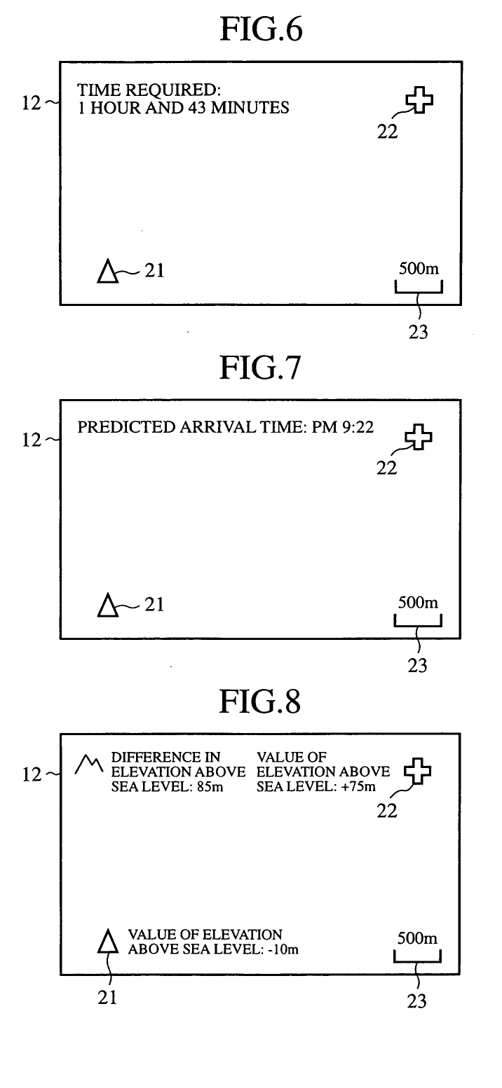

In a case where the user wants to check a time required in the state shown in FIG. 5, when the user presses a predetermined key of the input unit 11, the screen shown in FIG. 5 is changed to a screen shown in FIG. 6 to display the time required when the vehicle runs along the recommended route 24 in the left upper corner (in the example shown in FIG. 6, it is displayed that the time required is 1 hour and 43 minutes). At this point, when the time required is calculated, a predetermined average running speed is used.

In a case where the user wants to know an expected arrival time in the state shown in FIG. 6, when the user presses the predetermined key again, the screen shown in FIG. 6 is changed to a screen shown in FIG. 7 to display an expected arrival time when the vehicle runs along the recommended route 24 in the left upper corner of the screen (in the example shown in FIG. 7, it is displayed that expected arrival time is PM 9:22). Here, when the expected arrival time is calculated, a clock built-in the control unit 17 is used to display the expected arrival time when the present time is assumed as a starting time.

In a case where the user wants to know the difference in elevation above the sea level between the present vehicle position and the retrieving location in the state shown in FIG. 7, when the user presses the predetermined key again, the screen shown in FIG. 7 is changed to a screen shown in FIG. 8 to display the difference in elevation above the sea level in the left upper corner of the screen and to display heights above the sea level near the present vehicle position 21 and the retrieving location 22, respectively (in the example shown in FIG. 8, it is displayed that difference in elevation above the sea level is 85 m, height above the sea level of present vehicle position: −10 m, and height above the sea level of present retrieving location: +75 m).

In this regard, at the time of acquiring a height above the seal level, the control unit 17 controls the map information acquisition unit 14 to acquire the information of height above the seal level from the map information and finds the difference in the height above the seal level according to the information of height above the seal level. Further, in the state shown in FIG. 8, when the predetermined key is pressed again, the state shown in FIG. 8 is returned to the state shown in FIG. 5.

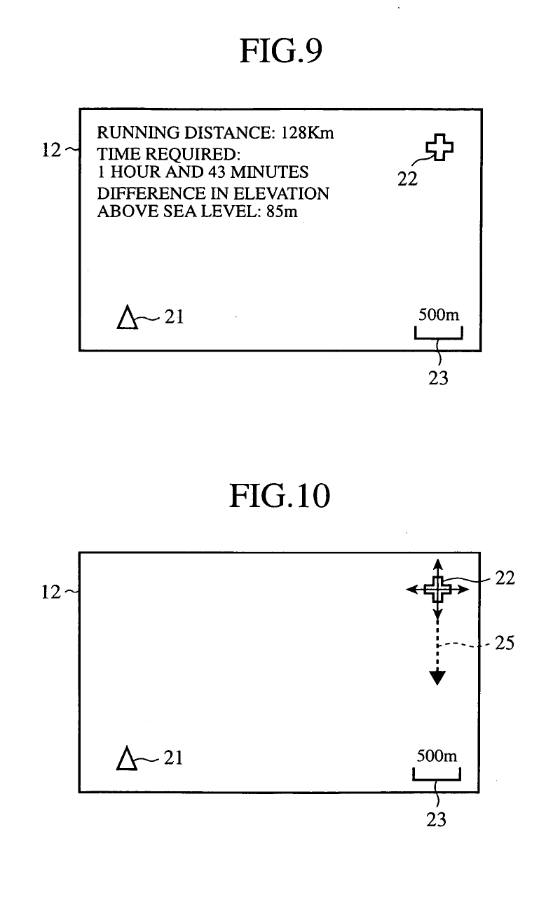

In the above example, an example has been described in which every time the predetermined key is pressed, the screen is changed from the state shown in FIG. 5 to the states shown in FIGS. 6, 7, and 8 in succession. However, it is also recommended that when the predetermined key is pressed in the state shown in FIG. 5, the screen is changed to a state shown in FIG. 9 to display the running distance, the time required, and the difference in elevation above the sea level in the left upper corner of the screen.

As described above, after the processing at step ST3 are performed, the control unit 17 displays an inquiry message to the effect whether or not the retrieving location concerned is appropriate for a destination (in other words, if the retrieving location is set as a destination) (step ST4). When the user inputs a command to the effect that he sets the retrieving location concerned for a destination through the input unit 11, the control unit 17 sets the retrieving location as the destination and controls the route search unit 16 to search the map information for a route from the present vehicle position to the destination (step ST5) and displays all the route from the present vehicle position to the destination in detail on the display unit 12 and displays the running distance, time required, and expected arrival time of all the route (step ST6).

Then, the control unit 17 displays again on the display unit 12 a message to the effect whether or not the retrieving location set as the destination is appropriate (step ST7), and when the user inputs a command to the effect that the retrieving location is appropriate for the destination through the input unit 11, the destination concerned and all the route are set as setting routes and guidance is provided according to this setting routes. At this point, step 17 may be omitted and, in this case, as shown by broken arrow in FIG. 2, the processing at step 6 are finished and then the processing may be finished.

Further, at step 2, when the user inputs through the input unit 11 a command to the effect that he does not want to grasp the location relationship, the processing proceeds to step 4 and when a command to the effect that the retrieving location is not appropriate for the destination is input at step 4, the processing returns to step ST1 where a retrieving location is again determined. Similarly, when a command to the effect that the retrieving location is not appropriate for the destination is input at step 7, the processing returns to step ST1 where a retrieving location is again determined.

Here, referring to FIG. 10 to FIG. 16, a control of changing the scale of map displayed on the display unit 12 with the movement of the retrieving location 22 on the screen will be described. It is assumed that to change a retrieving location, the user operates a cursor key to change the retrieving location to a lower end side (south end side) on the screen, that is, on the map, as shown in FIG. 10. In FIG. 10 to FIG. 15, an arrow mark 25 is a guideline of a direction in which the retrieving location mark 22 is headed and the arrow mark 25 is not displayed on the actual display unit 12.

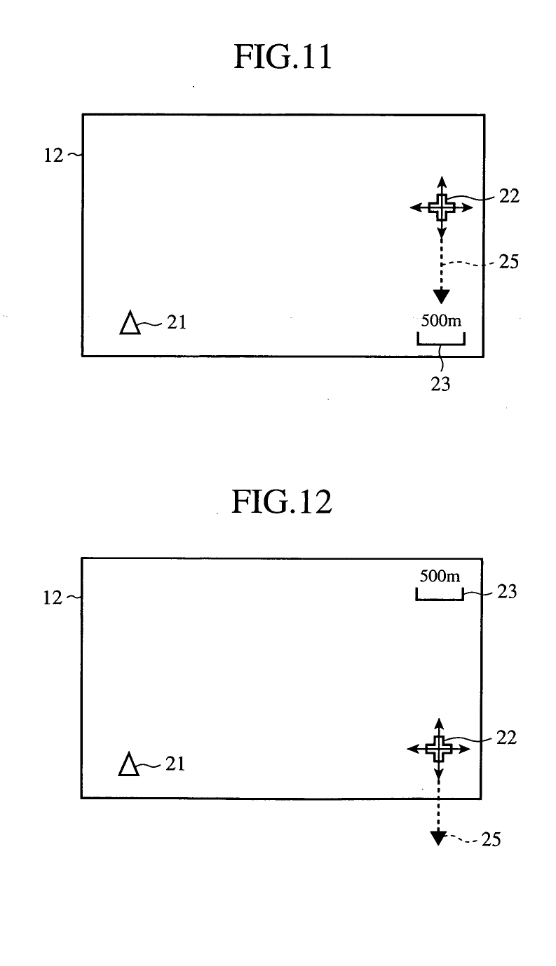

As the retrieving location mark 22 is moved downward on the screen, as shown in FIG. 11 and FIG. 12, the retrieving location mark 22 comes gradually nearer to the lower end side of the screen. In the state shown in FIG. 12, a scale (500 m) 23 which was displayed in the right lower corner of the screen overlaps the retrieving location mark 22, so that control unit 17 moves the scale 23 to the right upper corner of the screen to display the scale 23.

When the user moves the retrieving location mark 22 downward, as shown in FIG. 12, to make the retrieving location mark 22 come near to the lower end side of the screen, the control unit 17 stops the movement of the retrieving location mark 22 to fix the retrieving location mark 22 on the screen. Then, when the user moves the retrieving location mark 22 further downward, the control unit 17 moves upward the map displayed on the screen along with the present vehicle position mark 21. In other words, the control unit 17 moves upward the map displayed on the screen in FIG. 12 in a state where the present vehicle position mark 21 is fixed on the map displayed on the screen in the state shown in FIG. 12. As a result, the upper end side of the map in the state shown in FIG. 12 extends off the screen.

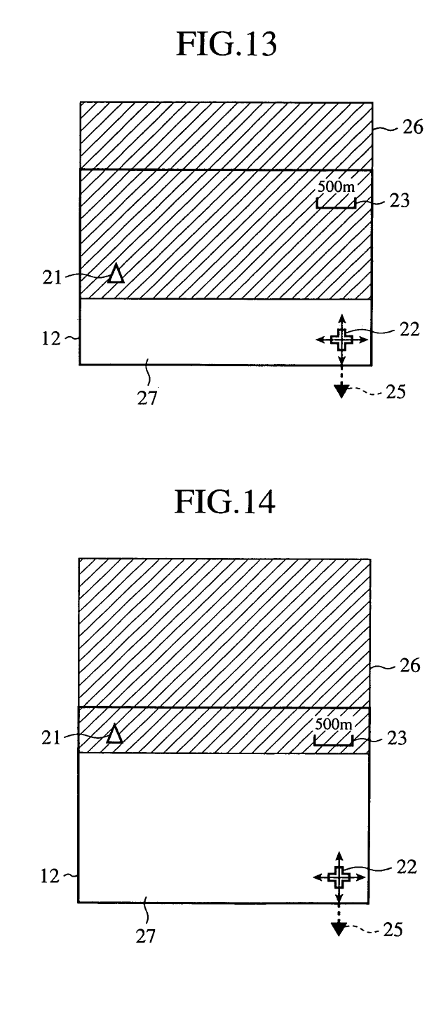

At this time, as shown in FIG. 13, a map continuous with the map displayed on the screen in FIG. 12 shows up from the lower end side of the screen and the retrieving location mark 22 is displayed on a newly showing-up screen. At this point, in FIG. 13, the map shown in FIG. 12 is shown by a diagonally shaded area 26 and a newly showing-up map is shown by a white area 27.

Further, when the user moves the retrieving location mark 22 to the lower end side, the control unit 17 moves the map (diagonally shaded area 26) upward, as shown in FIG. 14, with the retrieving location mark 22 fixed. At this time, another new map (white area) 27 shows up in the lower end side of the map 26.

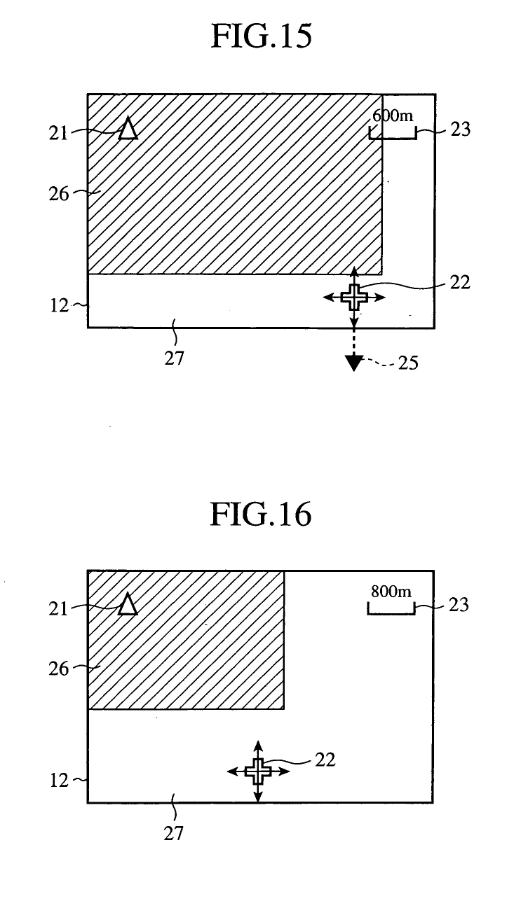

When the present vehicle position mark 21 reaches near the upper end side of the screen as shown in FIG. 14, the control unit 17 changes the scale. In other words, the control unit 17, as shown in FIG. 15, decreases the scale 23 (in the example shown, changed from 500 m to 600 m) to contract the maps 26 and 27. As a result, the present vehicle position mark 21 and the retrieving location mark 22 are displayed on the maps 26 and 27, respectively, that is, the present vehicle position mark 21 and the retrieving location mark 22 are displayed at the same time on the screen.

When the user further moves the retrieving location mark 22 from the state shown in FIG. 15 to the lower end side, the control unit 17 decreases the scale 23 further (in the example shown, changed from 600 m to 800 m) to display the present vehicle position mark 21 and the retrieving location mark 22 at the same time on the screen.

In this regard, an example has been described in which the retrieving location mark 22 is moved downward on the screen, but even when the retrieving location mark 22 is moved upward, leftward, or rightward on the screen, the control unit 17 performs display control in such a way that the present vehicle position mark 21 and the retrieving location mark 22 are displayed on the same screen.

In this manner, the control unit 17 changes the scale of map in such a way that the present vehicle position mark 21 and the retrieving location mark 22 are displayed on the same screen according to the movement of the retrieving location mark 22.

Incidentally, as is clear from the above descriptions, the position detection unit 13, the map information acquisition unit 14, the location retrieving unit 15, the route search unit 16, and the control unit 17 function collectively as display control unit and the control unit 17 and the input unit 11 function as setting unit.

As described above, according to embodiment 1, the vehicle mounted information guidance device is constructed in such a way that when a user sets his desired retrieving location at a preparatory stage for setting a destination, a screen is brought into a display state in which a present vehicle position and a retrieving location are displayed at the same time on a map displayed on the screen and that the user grasps the relationship between the present vehicle position and the retrieving location in the display state and sets whether or not the user select the retrieving location for the destination. Hence, the device produces an effect that the user can get information to show the relationship between the retrieving location and the present vehicle position at the preparatory stage for setting the destination and can set the destination with extreme ease.

According to embodiment 1, the vehicle mounted information guidance device is constructed in such a way that when the retrieving location on the map displayed on the screen is moved on the screen, the device changes the range of map displayed on the screen according to the movement of retrieving location to bring the screen into a state in which the retrieving location and the present vehicle position are displayed at the same time on the map displayed on the screen. Hence, the device produces an effect that even when the user moves the retrieving location, the user can easily grasp the relationship between the retrieving location and the present vehicle position on the map.

According to embodiment 1, the vehicle mounted information guidance device is constructed in such a way that one route from the present vehicle position to the retrieving location is displayed as a recommended route on the map displayed on the screen. Hence, the device produces an effect that the user can grasp the relationship between the retrieving location and the present vehicle position in more detail.

According to embodiment 1, the vehicle mounted information guidance device is constructed in such a way that the running distance when the vehicle runs along the recommended route is displayed on the screen. Hence, the device produces an effect that the user can grasp the running distance to the retrieving location and can accurately judge whether or not the user selects the retrieving location for the destination.

According to embodiment 1, the vehicle mounted information guidance device is constructed in such a way that a time required for the vehicle to go from the present position to the retrieving location when the vehicle runs along the recommended route or an expected arrival time when the vehicle arrives at the retrieving location is displayed on the screen. Hence, the device produces an effect that the user can get material for judgment when the user selects the retrieving location for the destination. Further, when the difference in elevation above the sea level between the present position and the retrieving location is displayed on the screen, the user can use the difference as a guideline when the user sets the destination.

1. A vehicle mounted information guidance device that guides a vehicle along a route on a map displayed on a screen of display unit on the basis of a present position of the vehicle and a destination, the device comprising:
display control unit that brings the screen into a state of display where the present position and a retrieving location desired by a user are displayed at the same time on the map displayed on the screen when a user sets the retrieving location at a preparatory stage for setting the destination; and
setting unit through which the user sets whether or not the user intends to make the retrieving location the destination according to a result of grasping a relationship between the present position and the retrieving location in the state of display.

2. The vehicle mounted information guidance device as claimed in claim 1, wherein when the retrieving location on the map displayed on the screen is moved on the screen, the display control unit changes a range of the map displayed on the screen according to the movement of the retrieving location to bring the screen into a state of display where the retrieving location and the present position are displayed at the same time on the map displayed on the screen.

3. The vehicle mounted information guidance device as claimed in claim 1, wherein the display control unit makes the display unit to display one route from the present position to the retrieving location as a recommended route on the map displayed on the screen.

4. The vehicle mounted information guidance device as claimed in claim 3, wherein the display control unit makes the display unit to display on the screen a running distance when the vehicle runs along the recommended route.

5. The vehicle mounted information guidance device as claimed in claim 1, wherein the display control unit makes the display unit to display on the screen a time required from the present position to the retrieving location or an expected arrival time when the vehicle runs along the recommended route.

6. The vehicle mounted information guidance device as claimed in claim 1, wherein the display control unit makes the display unit to display on a screen a difference in elevation above sea level between the present position and the retrieving location.
